(19) United States
(12) Patent Application Publication
(10) Pub. No.: US 2007/0134386 A1
(43) Pub. Date: Jun. 14, 2007

(54) Fruit slicer and dispenser device

(76) Inventors: Aupretre Shan Michael, Ajax (CA); Christopher Charles Aupretre, Ajax (CA)

Correspondence Address: GEORGE A. ROLSTON, 45 SHEPPARD AVE EAST, SUITE 900, TORONTO, ON, M2N5W9, CA

(21) Appl. No.: 11/604,221

(22) Filed: Nov. 27, 2006

Related U.S. Application Data
(60) Provisional application No. 60/739,926, filed on Nov. 28, 2005.

(51) Int. Cl. A23P 1/00

(52) U.S. Cl. 426/518

(57) ABSTRACT

A fruit slicer device for receiving a complete piece of fruit, and for slicing the fruit into segments and dispensing such segments one at a time as needed, while entrapping the remainder, and having a container for receiving a piece of fruit, a slicing component insertable into the container, spacer walls on the slicing component, and, knife blades on the spacer walls.

### FIELD OF THE INVENTION

The invention relates to a fruit slicer and dispenser for slicing fruit into wedges and dispensing the wedges.

### BACKGROUND OF THE INVENTION

In beverage facilities, and also in private homes it is desirable to be able to cut fruit, such as lemons or limes, into quadrant shaped segments or wedges. The wedges are then placed in the beverages. Cutting with a knife involves handling the fruit, and may result in uneven sized segments. Once cut the unused segments may be left lying on a plate, and may remain exposed to air borne contaminants for some time, before being used. Dispensing of the wedges often involves a piece of cutlery, or a simple toothpick, which may be handled with bare hands, and may further contaminate the fruit segments. This repeated handling of a piece of fruit is also, at the least, time consuming, and may slow down service, as well as involving possible health hazards. Cutting various kinds of fruit items into segments has been achieved in a variety of simple devices. Most of these do involve handling of the fruit, and do nothing to provide for safe contaminant free storage of unused fruit, or for dispensing segments as needed.

Clearly when cutting fruit into segments for dispensing into beverages such as in beverage establishments or even in a home, it is desirable as far as possible to avoid handling the fruit sections with the hands, for reasons of health and sanitation. Handling should be avoided both when cutting, and also when dispensing. Cutting using a knife may also be at the least messy, and may sometimes be hazardous, and should be avoided, if possible.

### BRIEF SUMMARY OF THE INVENTION

The invention provides a fruit slicer device in which a complete piece of fruit is placed in a container, and in which a slicing component is then inserted into the container, slicing the fruit within the container into equal size wedges or segments. A door on the container then permits individual wedges to be dispensed. All of this can be achieved without touching the item of fruit, other than to simply place it within the container.

The slicing component of the device contains a plurality of slicing blades and spacer walls. The entire slicing component is inserted within the container. Individual wedges can be accessed through an open door one at a time, and dispensed. The remaining wedges remain within the container, and thereby retain their freshness and do not become contaminated by lying around on a serving area for example.

Preferably the slicer device will provide a generally cylindrical container, with an open top. The slicing component will be a plurality of spacer walls, arranged radially around a centre, and extending at predetermined angles. The slicing component will have a top panel, sized to close the open end of the container. An opening and door is provided for dispensing individual segments.

In one embodiment, the opening and door may be in the side of the container. In another embodiment the opening and door may be in the top of the slicing component. Preferably the spacer walls on the slicing component will be of thermoplastic material. Knife blades will be embedded in the spacer walls, along their lower edges, for slicing the fruit.

A slidable collar fits around the spacer walls, and is releasably attachable to the container.

The container has guide grooves on the interior and guides are formed on the spacer walls.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is an exploded perspective illustration of a fruit slicer device illustrating the invention;

FIG. 2 is an upper perspective of the slicer component of FIG. 1;

FIG. 3 is a lower perspective of FIG. 2;

FIG. 4 is a perspective illustration of the container component of FIG. 1;

FIG. 5 is perspective illustration of a fruit slicer device assembled;

FIG. 6 is a section along 6-6 of FIG. 3, and,

FIG. 7 shows an alternate embodiment, with a door in the side of the container.

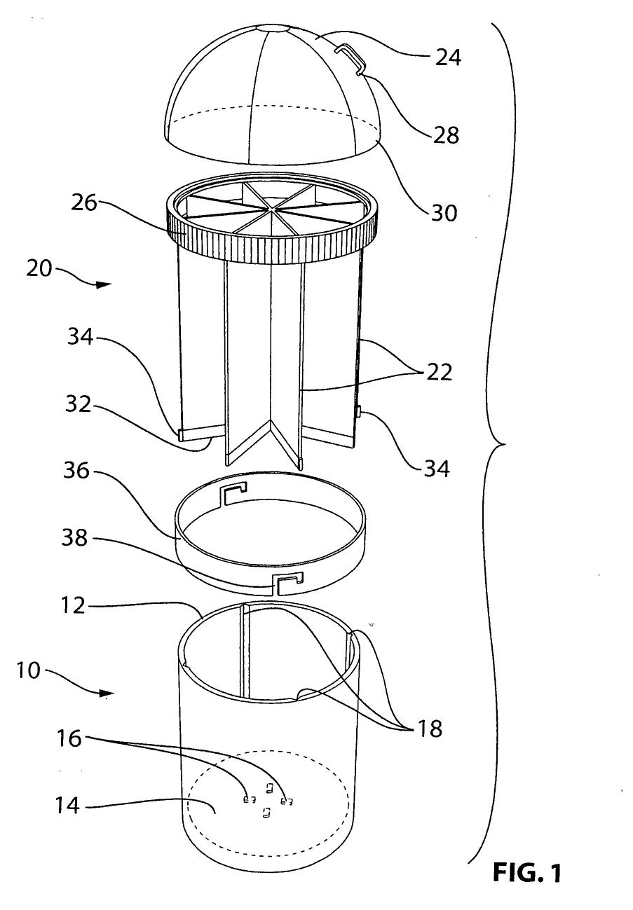

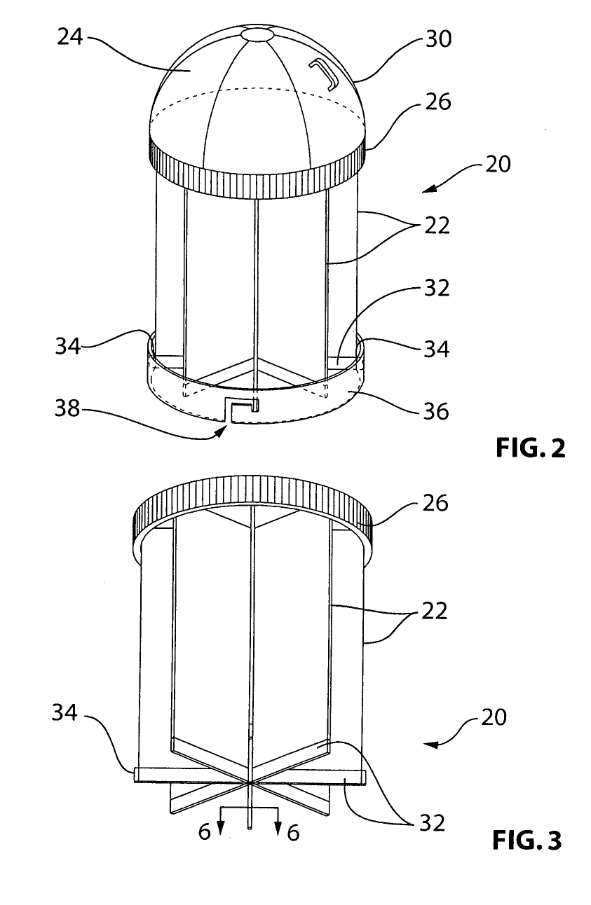

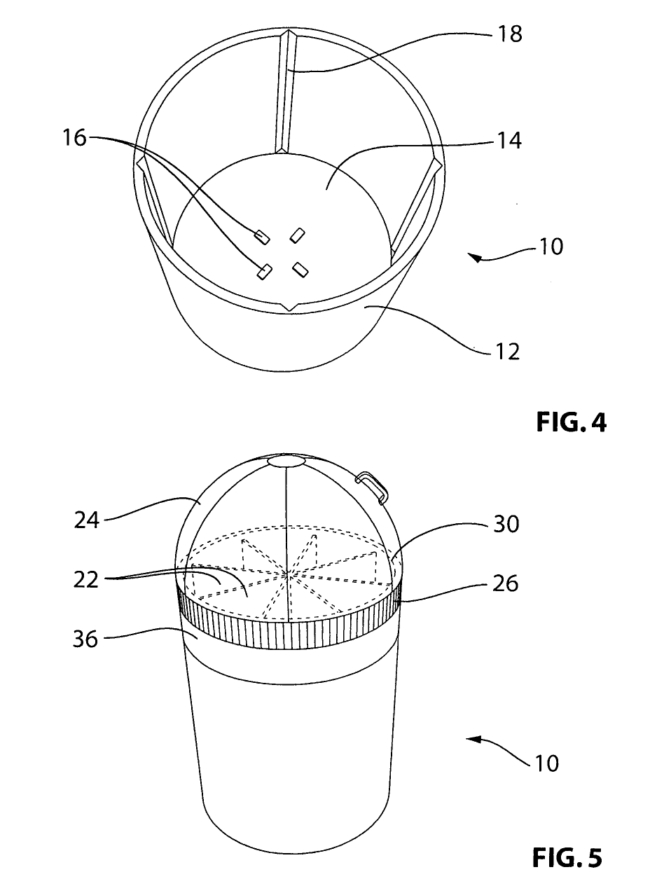

### DESCRIPTION OF A SPECIFIC EMBODIMENT

In the drawings the slicer device is shown as having a container illustrated generally as (10), and consisting in this case of an essentially more or less cylindrical sleeve portion (12). A base (14) closes the lower end. The upper end is open. It may be that it is desirable to make it slightly tapered from top to bottom for ease of use. Support walls (16) are supported on or moulded with the base (14) of container (10) Guide grooves (18) are formed within the container for reasons described below.

The fruit slicing component itself is shown as (20). It consists of a plurality of spacer walls (22), and a dome shaped top (24). The walls are arranged around 360° equally spaced apart to form octagonal divisions, each defining substantially equal angled segments. Other configurations are possible.

Top (24) is rotatably secured to walls (22) for dispensing.

A top ring (26) connects around the top of the spacer walls and is rotatable with top (24).

Ring (26) is knurled for gripping.

A dispensing opening (28), is formed in top (24).

A door (30) is swingably attached to top (24), for closing opening (28).

Knife blades (32) are embedded in or otherwise secured to the lower edges of spacer walls (22) for slicing the fruit as the slicing component (20) is pressed downwardly.

The walls (22) are typically formed of thermoplastic, and blades (32) are steel. In other designs the walls and blades can be integral.

Guides (34) are formed on walls (22) for riding in grooves (18).

A sliding collar (36) fits around walls (22). Collar has locking slots (38) for locking on abutments on container (10).

In use the portion of fruit typically, for example, a lime or a lemon, is placed within container (10). The lime or lemon is raised slightly and balanced on its centre by walls (16). This ensures proper orientation and alignment of the fruit within the container without having to trim the bottom of it to flatten it out. The slicing component (20) is then placed at the open end of the container.

The collar (36) is first locked on the container (10) by slots (38).

Component (20) is then pressed downwardly. The blades (32) will slice through the piece of fruit dividing it into segments. Guides (34) ride in grooves (18) during slicing.

In order to dispense a segment, top (24) of the slicing component is then rotated until a segment registers with the opening (28). The door (30) is then opened and the segment can be simply shaken out or dispensed for example using a tooth pick, or a clean utensil.

Rotating the top (24) will then bring the next fruit wedge into registration with opening (28) and so on. Until they are dispensed the fruit wedges remain enclosed and free of contamination.

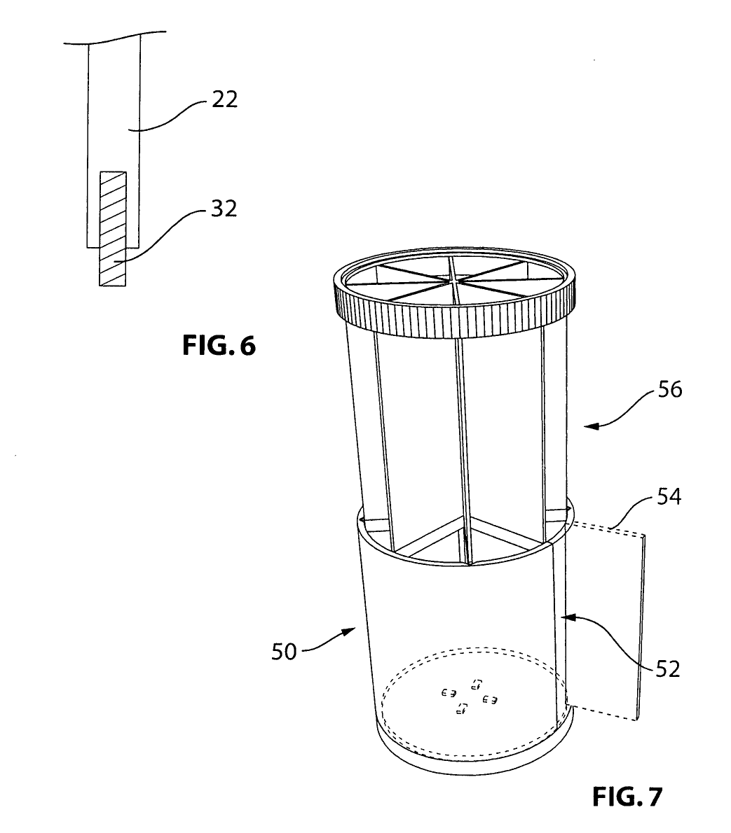

An alternate embodiment is shown in FIG. 6. In this case a container (50) has an opening (52) formed in the side. A door (54) can swing to close opening (52).

In this embodiment the entire slicing component (56) is rotatable within the container (50), so that a wedge can register with the opening (52). The segment can then be dispensed through the opening. The remaining segments are captured within the container, and remain fresh for later use.

The foregoing is a description of a preferred embodiment of the invention, which is given here by way of illustration. The invention is not to be taken as limited to any of the specific features described but comprehends all variations coming within the scope of the claims.

What is claimed is:

1. A fruit slicer device for receiving a complete piece of fruit, and for slicing the fruit into wedges or segments and dispensing such segments one at a time as needed, while entrapping and preserving the remainder, and comprising;
a container for receiving a piece of fruit;
a slicing component insertable into said container;
a plurality of spacer walls defined by said slicing component; and,
a plurality of knife blades on said spacer walls.

2. A fruit slicer device for receiving a complete piece of fruit, as claimed in claim 1 and including an opening for dispensing a segment of fruit from said container.

3. A fruit slicer device for receiving a complete piece of fruit, as claimed in claim 2, and including a top on said slicing component, and wherein said opening is formed in said top.

4. A fruit slicer device for receiving a complete piece of fruit, as claimed in claim 2 and wherein said opening is formed in said container, and including a door for closing said opening.

5. A fruit slicer device for receiving a complete piece of fruit, as claimed in claim 3 including a rotatable connection between said spacer walls and said top.

6. A fruit slicer device for receiving a complete piece of fruit, as claimed in claim 5 including a door in said top for closing said opening.

7. A fruit slicer device for receiving a complete piece of fruit, as claimed in claim 1 wherein said slicing component and said spacer walls are formed of thermoplastic material, and wherein said knife blades are embedded in said spacer walls.

8. A fruit slicer device for receiving a complete piece of fruit, as claimed in claim 3 including a slidable collar on said spacer walls, for attachment to said container.

9. A fruit slicer device for receiving a complete piece of fruit, as claimed in claim 3 including guide grooves formed within said container, and guides on said spacer walls.

10. A fruit slicer device for receiving a complete piece of fruit, as claimed in claim 3 and wherein said top is dome shaped.

11. A fruit slicer device for receiving a complete piece of fruit, as claimed in claim 4 wherein said spacer walls are rotatable within said container.

12. A fruit slicer device for receiving a complete piece of fruit, and for slicing the fruit into wedges or segments and dispensing such segments one at a time as needed, while entrapping and preserving the remainder, and comprising;
a container for receiving a piece of fruit;
guide grooves formed within said container;
a slicing component insertable into said container;
a top on said slicing component;
an opening formed in said top;
a door on said top for closing said opening,
a plurality of spacer walls defined by said slicing component;
a rotatable connection between said spacer walls and said top;
a slidable collar on said spacer walls, for attachment to said container;
knife blades on said spacer walls; and,
guides on said spacer walls;
